(19) United States
(12) Patent Application Publication
(10) Pub. No.: US 2022/0071215 A1
(43) Pub. Date: Mar. 10, 2022

(54) ANTIMICROBIAL AGENT INCLUDING SiOx NANOPARTICLES AND METHOD OF PREPARING ANTIMICROBIAL AGENT

(71) Applicant: Sangyeoul YOU, Ulsan (KR)

(72) Inventor: Sangyeoul YOU, Ulsan (KR)

(21) Appl. No.: 17/417,261

(22) PCT Filed: Jan. 19, 2020
(86) PCT No.: PCT/KR2020/000903

§ 371 Date: Jun. 22, 2021

(30) Foreign Application Priority Data
Jan. 23, 2019 (KR) 10-2019-0008424
Jan. 16, 2020 (KR) 10-2020-0005665

(51) Int. Cl. A01N 59/00; A01N 25/10; A01N 25/04; A01P 1/00

(52) U.S. Cl. CPC A01N 59/00; A01P 1/00; A01N 25/04; A01N 25/10

(57) ABSTRACT

The present invention provides an antimicrobial composition, comprising antimicrobial amorphous porous SiOx (0.1<x<2) particles, which is harmless to the human body, and a method for preparing the antimicrobial composition.

### TECHNICAL FIELD

The present invention relates to an antimicrobial composition including SiOx nanoparticles and a method of preparing the antimicrobial composition, and more particularly, to an antimicrobial composition including SiOx nanoparticles having a microstructure in which Si and SiO₂ crystal grains are dispersed in an amorphous SiOx region and a method of preparing the antimicrobial composition.

### BACKGROUND ART

Conventional antibiotics may be classified into cell wall-acting antibiotics, cell membrane-acting antibiotics, ribosome-acting antibiotics, and nucleic acid-acting antibiotics depending on the site of action. In addition, conventional antibiotics may be classified into penicillin, cephalosporin, monobactam, carbapenem, aminoglycoside, quinolone, etc. according to ranges of bacteria that exhibit antibiotic effects.

Antibiotics having activity of inhibiting bacterial cell wall synthesis exhibit antimicrobial activity by inhibiting bacterial cell wall synthesis. Antibiotics that mainly exhibit inhibitory effects on proliferating bacteria include penicillin-based antibiotics and cephalosporin-based antibiotics.

Antibiotics having activity of inhibiting bacterial cell membrane function change the permeability of cell membranes, disrupting the balance of the cellular system and causing bacterial cells to die. Cell membranes regulate introduction and release of cellular components by performing selective active transport. When the permeability of the cell membranes is changed abnormally, polymer substances or ions leak out of a cell, causing the cell to die. Examples of antibiotics having activity of bacterial cell membrane function includes polymyxin-based antibiotics. The polymyxin-based antibiotics are toxic to the kidneys and nerves.

In living organisms, DNA and RNA, which are genetic materials, are synthesized, and proteins are synthesized from the synthesized DNA and RNA. Antibiotics having activity of inhibiting bacterial growth inhibit this biosynthetic process. Depending on which step inhibited in the biosynthesis process, the antibiotics are classified into folic acid synthesis inhibitory antibiotics, nucleic acid synthesis antibiotics, and protein synthesis inhibitory antibiotics.

However, with recent emergence of multidrug resistant bacteria such as super bacteria, use of these antibiotics has been limited.

Recently, various substances have been used for sterilization and antimicrobial purposes. Inorganic complex compounds are known to have excellent sterilization ability against bacteria, fungi, and viruses while being harmless to the human body. However, despite the excellent effect of the inorganic complex compounds, since ultraviolet or sunlight is required for action of the inorganic complex compounds, there is a disadvantage that the inorganic complex compounds do not work in a place where there is no ultraviolet or sunlight.

SiOx-based antimicrobial agents are expected to solve these problems. However, use of SiOx particles for antimicrobial or sterilization has not yet been reported.

### DISCLOSURE

### Technical Problem

Therefore, the present invention has been made in view of the above problems, and it is one object of the present invention to provide an antimicrobial composition that has excellent antimicrobial activity, is harmless to the human body, and has economic advantages due to a simple preparation process.

### Technical Solution

In accordance with one aspect of the present invention, provided is an antimicrobial composition including SiOx nanoparticles or SiOx microparticles having a microstructure in which Si and SiO₂ crystal grains are dispersed in an amorphous SiOx region.

The SiOx antimicrobial particles may have a particle size of 5 nm to 10 μm, and the antimicrobial composition may further include a binder resin.

In the present specification, the SiOx particles may be silicon oxide particles including oxygen in a ratio of 0.1 or more and less than 2 by partially oxidizing non-hard silicon nanoparticies.

The antimicrobial composition may include a solution prepared by diluting the SiOx particles to a concentration of 1 to 1,000 ppm.

For example, the antimicrobial SiOx particles may have excellent antimicrobial activity. In addition, the antimicrobial SiOx particles may exhibit deodorization and air purification functions, and may be applied to various fields due to harmlessness thereof.

According to one embodiment, in the antimicrobial composition, the content of the SiOx particles may be 1 to 50,000 ppm.

According to one embodiment, the antimicrobial composition may further include a binder resin.

According to one embodiment, the binder resin may be selected from the group consisting of low-density polyethylene, high-density polyethylene, polypropylene, polystyrene, polyamide, polyester, polyvinyl alcohols, ethylene-propylene copolymers, polyurethane, polyurea, silicon resins, epoxy resins, and polymers consisting of one or more thereamong.

The polyurethane may be synthesized using polyol and (poly) isocyanate as precursors. In this case, the polyol may be selected from the group consisting of polycarbonate-based materials, polyester-based materials, polyacrylate-based materials, polyalkylene-based materials, and materials consisting of one or more thereamong. The polyol may have a weight average molecular weight (Mw) of 50 to 5,000. In addition, the polyol may include 45% by weight or less of a low molecular weight crosslinking agent having a weight average molecular weight (Mw) of 20 to 500.

The polyester may be obtained by polycondensing an aromatic dicarboxylic acid and an aliphatic glycol. Representative polyesters may include polyethylene terephthalate (PET), polyethylene-2,6-naphthalenedicarboxylate (PEN), and the like. The polyester may be a copolymer containing a third component. The dicarboxylic acid component of the copolymerized polyester may include isophthalic acid, phthalic acid, terephthalic acid, 2,6-naphthalenedicarboxylic acid, adipic acid, sebacic acid, and oxycarboxylic acid (e.g., p-oxybenzoic acid). The glycol component may include ethylene glycol, di ethylene glycol, propylene glycol, butanediol, 1,4-cyclohexanedimethanol, and neopentyl glycol. The dicarboxylic acid component and the glycol component may be used in combination of two or more thereof.

In the preparation of the SiOx particles, by directly applying heat to silicon nanoparticles or silicon microparticles using an infrared ceramic heater while flowing air, SiOx nanoparticles or SiOx microparticles having a microstructure in which. Si and SiO₂ crystal grains are dispersed in an amorphous SiOx region may be prepared.

A solution-type antimicrobial and bactericidal composition may be prepared by dispersing the nanoparticles in a solvent such as water or an organic solvent. A gel-type antimicrobial composition may be prepared by dispersing the nanoparticles in glycerin, a higher alcohol, an aromatic polyol, a carboxylate, a surfactant, hydrogel, or the like. In addition, a resin-type antimicrobial composition may be prepared by dispersing the nanoparticles in various binder resins.

Coating agents and liquid fragrances such as diffusers may be manufactured using the solution-type antimicrobial composition. Products such as soap, hand sanitizers, shampoo, body lotion, hair gel, and hair spray may be manufactured using the gel-type antimicrobial composition. Products such as fiber, fabric, non-woven fabric, films, and sheets may be manufactured using the resin-type antimicrobial composition. In addition, the surface of a substrate such as fiber, nonwoven fabric, a film, and a sheet manufactured using the resin-type antimicrobial composition may be coated with the solution-type antimicrobial composition.

In particular, since the antimicrobial agent including the SiOx nanoparticles having a size of 5 nm to 100 nm has an amorphous porous structure, the antimicrobial agent may be completely dispersed in physiological saline. Thus, the antimicrobial agent including the SiOx nanoparticles may be effectively delivered to various tissues (brain, kidneys, lungs, etc.). In addition to extermination of viruses that cause various diseases, the antimicrobial agent may be used in drug delivery systems necessary for treatment of diseases such as Alzheimer's disease.

### Advantageous Effects

According to one aspect of the present invention, antimicrobial composition having excellent antimicrobial activity even at low concentration can be prepared by controlling the particle size and oxygen content of SiOx particles within a certain range. In addition, since the preparation process for the antimicrobial composition is simple, the antimicrobial composition is advantageous in terms of productivity and economics.

The effects of the present invention are not limited to the above effects, and should be understood to include all effects that can be deduced from the configuration of the invention described in the detailed description or claims of the present invention.

### DESCRIPTION OF DRAWINGS

FIG. 1 illustrates an apparatus for oxidizing Si nanoparticles using an infrared heater and an ultrasonic device by adding oxygen or water.

10: SiOx preparation apparatus, 11: gas inlet, 12: gas outlet, 13: UV or infrared generator, 14: ultrasonic generators, 15: magnetic stirrer, 16: thermometer, 17: power supply line, and 18: nanoparticles

### BEST MODE

Antimicrobial SiOx (0.1<x<1.2) particles have a particle size of 5 nm to 100 nm, and are dispersed in water, an organic solvent, a polymer material, and the like. In this case, represents oxygen content.

### MODE FOR INVENTION

The present invention may be implemented in various different forms and is not limited to these embodiments. To clearly describe the present invention, a part unrelated to the description is omitted in the drawings, and the same or similar elements are designated by the same reference numerals throughout the specification.

It should be understood that when an element is referred to as being “connected to” or “coupled to” another element, the element may be directly connected or coupled to the other element or intervening elements may be present. In addition, in the present invention, it is to be understood that, unless stated otherwise, when a part “comprises” any element, the part may include other elements without excluding other elements.

Hereinafter, an embodiment of the present invention will be described in detail.

### Preparation Example 1

SiOx nanoparticles may be prepared according to Reaction Formula 1 below.

Si particles+½×O₂→SiOx particles <Reaction Formula 1>

SiOx particles are prepared by directly radiating infrared/ultraviolet rays to silicon nanoparticles or silicon microparticles. At this time, by adjusting the temperature of a ceramic heater within a range of 50 to 600° C. or applying ultraviolet rays having a wavelength of 200 to 400 nm, the flow rate of the air, stirring speed, the intensity of ultrasonic waves, reaction time, etc., may be adjusted to determine the degree of oxidation and adjust particle size.

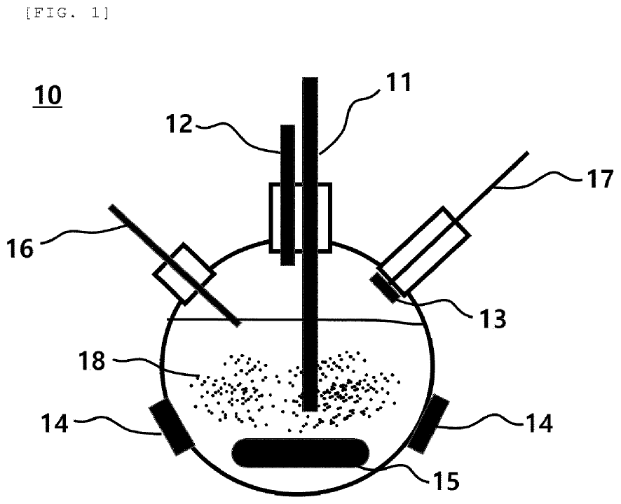

After putting 10 g of silicon particles into the apparatus shown in FIG. 1, the silicon particles were stirred at 2,000 rpm per minute while supplying air having a relative humidity of 80% at a rate of mi/min to obtain SiOx particles. At this time, Samples 1 to 12 were prepared according to temperatures of 100° C., 300° C., and 500° C., reaction time of 10 minutes and 30 minutes, and the presence/absence of ultrasonic waves.

TABLE 1

| | | Reaction | Ultrasonic | Average | |
|---|---|---|---|---|---|
| | | temp- | waves | particle | Oxygen |
| Classi- | Reaction | erature | (present/ | size | content |
| fication | time | (° C.) | absent) | (nm) | (x) |
| Raw | | | | 30 | <0.01 |
| materials | | | | | |
| Sample 1 | 10 | 100 | Absent | 40 | <0.1 |
| | min. | | | | |
| Sample 2 | 10 | 300 | Absent | 160 | 0.2 |
| | min. | | | | |
| Sample 3 | 10 | 500 | Absent | 500 | 0.3 |
| | min. | | | | |
| Sample 4 | 10 | 100 | Present | 30 | 0.16 |
| | min. | | | | |
| Sample 5 | 10 | 300 | Present | 40 | 0.32 |
| | min. | | | | |
| Sample 6 | 10 | 500 | Present | 50 | 0.35 |
| | min. | | | | |
| Sample 7 | 30 | 100 | Absent | 80 | 0.3 |
| | min. | | | | |
| Sample 8 | 30 | 300 | Absent | 300 | 1.2 |
| | min. | | | | |
| Sample 9 | 30 | 500 | Absent | 1,000 | 1.5 |
| | min. | | | | |
| Sample 10 | 30 | 100 | Present | 30 | 0.3 |
| | min. | | | | |
| Sample 11 | 30 | 300 | Present | 50 | 1.5 |
| | min. | | | | |
| Sample 12 | 30 | 500 | Present | 60 | 1.8 |
| | min. | | | | |

### Example 1

Antimicrobial compositions were prepared by dispersing antimicrobial SiOx particles (Samples 1 to 12) prepared according to Preparation Example 1 at a concentration of 2 mM/L in water. After spray-coating a shoe insole with the antimicrobial composition and drying the shoe insole with warm air for 6 hours, the antibacterial activity of the composition against bacteria A (Staphylococcus aureus ATCC 6538) and bacteria B (Klebsiella pneumoniae ATCC 4352) was measured according to KS K 0693:2011, which is an antibacterial test method, and results are shown in Table 2,

TABLE 2

| | | Density | | Density | |
|---|---|---|---|---|---|
| | Density | of | | of | |
| | of | bacteria | Anti- | Bacteria | Anti- |
| | bacteria | A | bacterial | B | bacterial |
| | A, B | (number | rate of | (number | rate of |
| | (number | of | bacteria | of | bacteria |
| | of | bacteria/ | A (%, | bacteria/ | B |
| Classi- | bacteria/ | mL, after | after | mL, after | (%, after |
| fication | mL, early) | 18 hr) | 18 hr) | 18 hr) | 18 hr) |
| Sample 1 | 2.0 × | <10 | 99.9 | <10 | 99.9 |
| | 10⁴ | | | | |
| Sample 2 | 2.0 × | <10 | 99.9 | <10 | 99.9 |
| | 10⁴ | | | | |
| Sample 3 | 2.0 × | <10 | 99.9 | <10 | 99.9 |
| | 10⁴ | | | | |
| Sample 4 | 2.0 × | <10 | 99.9 | <10 | 99.9 |
| | 10⁴ | | | | |
| Sample 5 | 2.0 × | <10 | 99.9 | <10 | 99.9 |
| | 10⁴ | | | | |
| Sample 6 | 2.0 × | <10 | 99.9 | <10 | 99.9 |
| | 10⁴ | | | | |
| Sample 7 | 2.0 × | <10 | 99.9 | <10 | 99.9 |
| | 10⁴ | | | | |
| Sample 8 | 2.0 × | <10 | 99.9 | <10 | 99.9 |
| | 10⁴ | | | | |
| Sample 9 | 2.0 × | <10 | 99.9 | <10 | 99.9 |
| | 10⁴ | | | | |
| Sample 10 | 2.0 × | <10 | 99.9 | <10 | 99.9 |
| | 10⁴ | | | | |
| Sample 11 | 2.0 × | <10 | 99.9 | <10 | 99.9 |
| | 10⁴ | | | | |
| Sample 12 | 2.0 × | <10 | 99.9 | <10 | 99.9 |
| | 10⁴ | | | | |
| Com- | 2.0 × | 2.0 × | — | 2.0 × | — |
| parative | 10⁴ | 10⁶ | | 10⁶ | |
| Example | | | | | |
| (blank) | | | | | |

### Example 2

LOPE, PP, and PET materials each including 5% of the antimicrobial SiOx particles (Samples 2, 6, and 10) prepared according to Preparation Example 1 were each compounded with master batch prepared using a 2-axis processing machine to obtain antimicrobial polymer chips containing the PE, PP, or PET material at concentration of 1 ppm, 50 ppm, 100 ppm, 300 ppm, 1,000 ppm, and 5,000 ppm, and short fibers (Samples 2-1 to 2-6, 6-1 to 6-6, 10-1 to 10-6) were manufactured. Then, the antibacterial activity of the sample against bacteria A. (Staphylococcus aureus ATCC 6538) and bacteria B (Klebsiella pneumoniae ATCC 4352) was measured according to KS K 0693:2011, which is an antibacterial test method, and results are shown in Tables 3 and 4.

TABLE 3

| | Bacterial density unit, antibacterial rate (%), early | | | | | | |
|---|---|---|---|---|---|---|---|
| | bacterial concentration: 2.0 × 10⁴ | | | | | | Comparative |
| Classification | 1 | 50 | 100 | 300 | 1,000 | 5,000 | Example |
| (bacteria A) | ppm | ppm | ppm | ppm | ppm | ppm | (Blank) |
| Sample 2 | 82.3 | 99.9 | 99.9 | 99.9 | 99.9 | 99.9 | 2.0 × 10⁶ |
| (2-1 to 2-6) | | | | | | | |
| Sample 8 | 67.5 | 99.9 | 99.9 | 99.9 | 99.9 | 99.9 | 2.0 × 10⁶ |
| (6-1 to 6- 6) | | | | | | | |
| Sample 12 | 70.2 | 99.9 | 99.9 | 99.9 | 99.9 | 99.9 | 2.0 × 10⁶ |
| (10-1 to 10-6) | | | | | | | |

TABLE 4

| | Bacterial density unit, antibacterial rate (%), early | | | | | | |
|---|---|---|---|---|---|---|---|
| | bacterial concentration: 2.0 × 10⁴ | | | | | | Comparative |
| Classification | 1 | 50 | 100 | 300 | 1,000 | 5,000 | Example |
| (bacteria B) | ppm | ppm | ppm | ppm | ppm | ppm | (Blank) |
| Sample 2 | 45.2 | 99.9 | 99.9 | 99.9 | 99.9 | 99.9 | 2.0 × 10⁶ |
| (2-1 to 2-6) | | | | | | | |
| Sample 8 | 49.5 | 99.9 | 99.9 | 99.9 | 99.9 | 99.9 | 2.0 × 10⁶ |
| (6-1 to 6-6) | | | | | | | |
| Sample 12 | 46.7 | 99.9 | 99.9 | 99.9 | 99.9 | 99.9 | 2.0 × 10⁶ |
| (10-1 to 10-6) | | | | | | | |

The aforementioned description of the present invention provided by way of example and those skilled in the art will understand that the present invention can be easily changed or modified into other specified forms without change or modification of the technical spirit or essential characteristics of the present invention. Therefore, it should be understood that the aforementioned examples are only provided by way of example and not provided to limit the present invention. For example, each of constituents described as a single form may be separately implemented and, similarly, constituents described as being separated may be implemented in combined form.

It should be understood that the scope of the present invention is defined by the following claims and the invention is to cover all modifications, equivalents, and alternatives falling within the spirit and scope of the invention as defined by the claims.

### INDUSTRIAL APPLICABILITY

In the preparation of the SiOx particles, by directly applying heat to silicon nanoparticles or silicon microparticle s using an infrared ceramic heater while flowing air, SiOx nanoparticles or SiOx microparticles having a microstructure in which Si and SiO₂ crystal grains are dispersed in an amorphous SiOx region can be prepared.

A solution-type antimicrobial and bactericidal composition can be prepared by dispersing the nanoparticles in solvent such as water or an organic solvent. A gel-type antimicrobial composition can be prepared by dispersing the nanoparticles in glycerin, a higher alcohol, an aromatic polyol, a carboxylate, a surfactant, hydrogel, or the like. In addition, a resin-type antimicrobial composition can be prepared by dispersing the nanoparticles in various binder resins.

Coating agents and liquid fragrances such as diffusers can be manufactured using the solution-type antimicrobial composition. Products such as soap, hand sanitizers, shampoo, body lotion, hair gel, and hair spray can be manufactured using the gel-type antimicrobial composition. Products such as fiber, fabric, non-woven fabric, films, and sheets can be manufactured using the resin-type antimicrobial composition. In addition, the surface of a substrate such as fiber, nonwoven fabric, film, and a sheet manufactured using the resin-type antimicrobial composition can be coated with the solution-type antimicrobial composition.

In particular, since the antimicrobial agent including the SiOx (0.1<x<1.4) nanoparticles having a size of 5 nm to 100 am has an amorphous porous structure, the antimicrobial agent can be completely dispersed in physiological saline. Thus, the antimicrobial agent including the SiOx nanoparticles can be effectively delivered to various tissues (brain, kidneys, lungs, etc.). In addition to extermination of viruses that cause various diseases, the antimicrobial agent can be used in drug delivery systems necessary for treatment of diseases such as Alzheimer's disease.

1. An antimicrobial composition, comprising SiOx (0.1<x<2) particles having a particle size of 5 nm to 1 μm.

2. The antimicrobial composition according to claim 1, wherein the antimicrobial composition contains the particles in an amount of 1 ppm to 100%.

3. The antimicrobial composition according to claim wherein the antimicrobial composition is a liquid-type or gel-type antimicrobial composition dispersed in water, glycerin, a higher alcohol, an aromatic polyol, a carboxylate, a surfactant, hydrogel, and the like.

4. The antimicrobial composition according to claim 2, wherein the antimicrobial composition further comprises a binder resin.

5. The antimicrobial composition according to claim 4, wherein the binder resin is selected from the group consisting of low-density polyethylene, high-density polyethylene, polypropylene, polystyrene, polyamide, polyester, polyvinyl alcohols, ethylene-propylene copolymers, polyurethane, polyurea, silicon resins, epoxy resins, and polymers consisting of one or more thereamong.

6. A method of synthesizing antimicrobial SiOx particles, comprising a step of oxidizing silicon particles using a gas containing water, hydrogen peroxide, oxygen, or ozone while applying infrared or ultraviolet rays to the silicon particles, wherein, in the step, an ultrasonic device is used as a device for preventing coagulation.
